(19) United States
(12) Patent Application Publication
(10) Pub. No.: US 2015/0067715 A1
(43) Pub. Date: Mar. 5, 2015

(54) SECURE EVENT BROADCASTING SYSTEM AND METHOD

(71) Applicants: Peter Koat, Surrey (CA); Philip Nerland, Vancouver (CA); Bryan Chow, Delta (CA)

(72) Inventors: Peter Koat, Surrey (CA); Philip Nerland, Vancouver (CA); Bryan Chow, Delta (CA)

(21) Appl. No.: 14/236,875

(22) PCT Filed: Aug. 3, 2012
(86) PCT No.: PCT/CA2012/050529

§ 371 Date: Oct. 27, 2014

Related U.S. Application Data
(60) Provisional application No. 61/514,706, filed on Aug. 3, 2011.

(51) Int. Cl. H04N 21/254; H04N 21/475; H04N 21/2543; H04N 21/27; H04H 60/15; H04N 21/24

(52) U.S. Cl. CPC H04N 21/2541; H04H 60/15; H04N 21/2407; H04N 21/2543; H04N 21/27; H04N 21/4753
USPC 725/25; 725/1; 725/30

(57) ABSTRACT

The present technology provides a secure event broadcasting system and method. In particular, the secure event broadcasting system and method provides for the compression of event video content at a specified compression ratio and video quality, uploading of the compressed video to a content delivery network and controlled access to the compressed video by invited viewers.

### FIELD OF THE INVENTION

The technology relates generally to the field of video streaming and compression and in particular, to a secure event broadcasting system and method.

### BACKGROUND

Conventional webcasting requires the content to be hosted on a website that the viewer is visiting. The user would simply click on a link on the website to connect to the hosted content. Despite the apparent ease of this approach, webcast files are typically very large and require an assortment of administrative controls to permit a structured delivery of the webcast content as well as add-ons, thereof to users.

Accordingly, conventional webcasting requires a webcaster to host, service, administrate, and manage delivery of the webcast content on their servers to users visiting their website. This entails a significant amount of data storage and overhead for a webcast provider.

It would be, therefore, desirable for systems and methods that enable the convenient delivery of webcast content to a user without requiring the webcaster to commit the significant resources necessary for a webcast.

This background information is provided to reveal information believed by the applicant to be of possible relevance to the present invention. No admission is necessarily intended, nor should be construed, that any of the preceding information constitutes prior art against the present invention.

### SUMMARY OF THE INVENTION

An object of the present invention is to provide a secure event broadcasting system and method. In accordance with an aspect of the present invention, there is provided a secure event broadcasting system comprising an event scheduling server configured to provide event management and invitation access management; one or more encoder appliances configured to encode and upload content to a content delivery network in response to instructions from the event scheduling server; and one or more viewer applications configured to communicate with the event scheduling server and receive invitations to one or more broadcasting events therefrom; wherein specific uploaded content corresponds to a broadcasting event and the invitation at least in part provides access to the specific uploaded content on the content delivery network.

In accordance with another aspect of the invention, there is provided a method for secure event broadcasting comprising: receiving video content of an event; compressing the video content at a specified compression ratio and video quality to obtain a compressed video having a specific quality in response to instructions from a event scheduling server; uploading compressed video content to a content delivery network; providing an invitation to the event to a viewer application, wherein the viewer application can access and playback the compressed video content from the content delivery network based at least in part on the invitation.

### BRIEF DESCRIPTION OF THE FIGURES

FIG. 1 illustrates a schematic detailing of the secure event broadcasting system in accordance with embodiments of the present technology.

FIG. 2 illustrates an encoder use case diagram in accordance with embodiments of the present technology.

FIG. 3 illustrates an encoder sequence diagram in accordance with embodiments of the present technology.

FIG. 4 illustrates a viewer/viewer application/viewer computing device use case diagram in accordance with embodiments of the present technology.

FIG. 5 illustrates a viewer/viewer application/viewer computing device sequence diagram in accordance with embodiments of the present technology.

FIG. 6 illustrates a client (owner/supplier of video content) use case diagram in accordance with embodiments of the present technology.

FIG. 7 illustrates a client (owner/supplier of video content) sequence diagram in accordance with embodiments of the present technology.

### DETAILED DESCRIPTION OF THE INVENTION

As used herein, the term “about” refers to a +/−10% variation from the nominal value. It is to be understood that such a variation is always included in a given value provided herein, whether or not it is specifically referred to.

Unless defined otherwise, all technical and scientific terms used herein have the same meaning as commonly understood by one of ordinary skill in the art to which this invention belongs.

The present technology provides for event broadcasting to a large number of attendees using a collaborative, interactive environment. Event broadcasting is delivered in standard definition or high definition video and audio and may be provided as a live stream, on-demand or as a scheduled event. In some embodiments, live streaming events are also stored by the system for later broadcasting as an on-demand or scheduled viewing event.

The system and method of the present technology are applicable for a wide range of event broadcasts including but not limited to educational events, sporting events, entertainment events, corporate meetings, or the like, etc.

In some embodiments, the present technology features a flexible signal input with a broad range of options for application in studio, contribution feeds, webcasting, sporting events, web deployments and the like. The system is built around a content delivery network backbone to mitigate signal loss and allow access to a large number of attendees around the world, without the need for an expensive and/or cumbersome load-balanced internet infrastructure solution to maintain.

The system includes an encoder appliance, wherein video content is encoded and compressed for transmission to one or more content delivery networks and a client application configured to receive and decode the encoded content for subsequent consumption by the attendee or viewer, for example the viewer of the video content. The encoder appliance and the viewer interface/application are communicatively linked by an event scheduling server. The event scheduling server is configured for controlling content, access to the content, tracking delivery of the content, consumption of the content, uploading of the content and the like. Optionally, the event scheduling server is configured, for example by means of analytics, to track the dates, durations and times of delivery of the video content, which is at least in part used for the determination of the associated cost to the client. In some embodiments, the client which uses the system is the entity that provides the video content, wherein this client can be billed based at least in part on the number of attendees that consume this particular video content. In some embodiments, the client can be the attendee or viewer, wherein the client is billed for the specific video content which is consumed thereby.

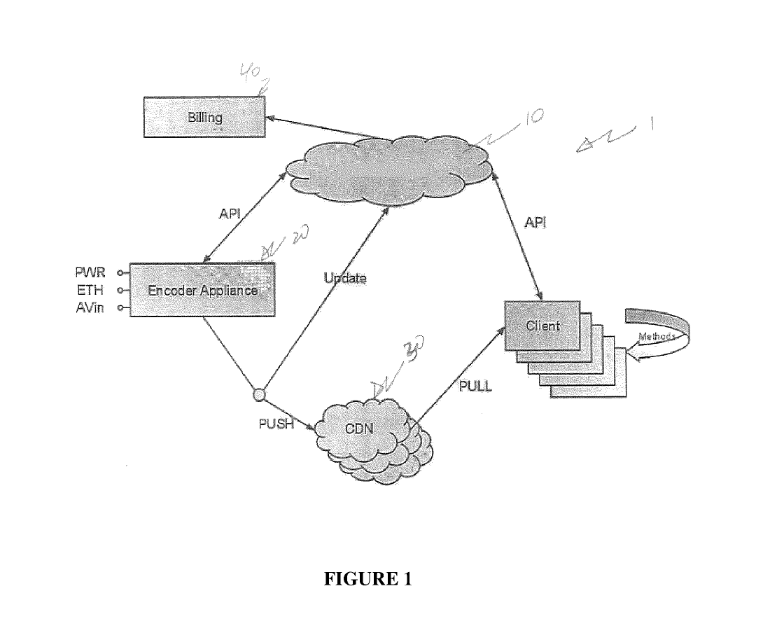

Referring to FIG. 1, the secure event broadcasting system (1) includes an event scheduling server (10) configured to provide event management and control access to the events. In particular, the event scheduling server (10) is configured to communicate with and provide instructions to one or more encoder appliances (20). The encoder appliances (20) receive video input and compress the video content at a specified compression ratio and video quality to obtain compressed video content having a specific quality in response to instructions from the event scheduling server (10) or instructions inputted directly into the encoder appliance. The compressed video content is uploaded to a content delivery network (CDN) (30) and the event scheduling server (10) is optionally updated to reflect the change in status and for example stream statistics. The uploaded video content is transmitted to a CDN domain name, specific URL or otherwise tagged to facilitate retrieval.

Access to the uploaded video content is managed by the event scheduling server (10). In some embodiments, the event scheduling server (10) provides access to the event by forwarding an event invitation to a viewer application/viewer computing device, wherein the invitation includes a uniform resource locator (URL), or other location identifier, to the event. The event invitation can further include an event code and access personal identification number (PIN). Additional information including start and stop times for the event, event duration, a custom message or the like or combination thereof may be included with the event invitation. In some embodiments for on-demand or scheduled viewing of video content, the event invitation may further indicate when access to compressed video content of the event expires.

In some embodiments, each invitation to an event includes a unique time-based URL wherein the URL expires after a set period of time to further limit event access.

Once the compressed video content is accessed, the video content is provided to the viewer as a streaming video, a download or a progressive download. In embodiments where offline replay is to be allowed, content is downloaded.

In some embodiments, the system is further operatively associated with a financial server (40) to facilitate billing of the use of the system by one or more clients. In some embodiments, the financial server is configured to enable the billing of the client based on time of use of the system for the viewing of the particular video content, by one or more viewers.

### Event Scheduling Server

The event scheduling server provides event and invitation management access for applications and external clients, for example viewer computing devices/viewer applications, video content suppliers or owners, and the like. A plurality of functionalities are provided by the event scheduling server including but not limited to listing available events, scheduling new events, modifying and cancelling scheduled events, inviting or revoking viewers to scheduled events, modifying and cancelling scheduled events and the like. In some embodiments, the event scheduling server provides statistical analysis of event attendance including number of attendees, percent of invitees that attended the event, average length of viewership, and the like. The event scheduling server can also provide for confirmation of attendance and monitor and provide viewing analytics, which can be used for billing purposes.

According to embodiments, the event scheduling serer is configured to control the operation of the encoder appliance and the invitation and authorization of a viewer computing device's access to the content which is available on the CDN. The interactions between the encoder appliance and the event scheduling server is enabled using an appropriate application program interface (API) configured for the transmission of required instructions and information between the encoder appliance and the event scheduling server. In addition, the interactions between the viewer computing device/viewer application and the event scheduling server is enabled using an appropriate application program interface (API) configured for the transmission of required instructions and information between the viewer application/viewer computing device and the event scheduling server.

According to embodiments, interaction between the encoder appliance and the event scheduling server includes a substantially continual handshake. For example, a substantially continual handshake can be a reestablishment of authorized communication every 1 second, 2 seconds or the like, as would be readily understood. This substantially continual interaction between the encoder device and the event scheduling server provides a means for the provision of instructions to the encoding application on the encoder appliance wherein these instructions can be at least in part related to the manner in which to encode the video content, where to put the compresses video content on the CDN, update the event scheduling server upon uploading of new compresses video content and the like.

According to embodiments, interaction between the viewer computing device/viewer application and the event scheduling server is also a substantially continual handshake. For example, a substantially continual handshake can be a reestablishment of authorized communication every 1 second, 2 seconds or the like, as would be readily understood. This substantially continual interaction between the viewer computing device/viewer application and the event scheduling server can provide for a substantially continual update on the process of the provision of the data representative of the desired event to the viewer computing device/viewer application. For example, this data can be representative of the subsequent collection of compressed video content portions to be downloaded by the viewer computing, current status of the compressed video content of the desired event if a portion or all of the respective compressed video content is unavailable, meta-data stream which may include instant messaging or list of viewers/attendees and the like.

According to embodiments, the event scheduling server is configured to provide an invitation to a viewer computing device/viewer application, such that the invitation is a link to the authorization mechanism which can authorize the viewer computing device access to the desired content on the CDN. In some embodiments, this authorization can include a password or other mechanism for verification of the viewer computing device/viewer application (or user thereof) for access to the content on the CDN. Upon authorization, the event scheduling server can provide the viewer computing device with access information and/or details for the content on the CDN. For example, this access information can include access details to the CDN as well or alternately to the specific location of the desired content on the CDN.

According to embodiments, the event scheduling server is configured to archive live events, namely archive the compressed video content generated by the encoder device during the live event, delete or rebroadcast previously encoded video content events as either on-demand events or scheduled delivery events. For example, the event scheduling server includes or is operatively coupled to one or more memory storage devices, which can be configured to provide archiving. According to embodiments, this rebroadcasting of an event can enable the previously encoded video content to be transmitted to a new list of viewers which may or may not be the same as the original list of viewers of the previous broadcast of the same event.

According to some embodiments, the event scheduling server is configured to replicate encoded video content for subsequent provision to additional CDNs when a plurality of CDNs may be required for a high number of viewers. For example, if the event being broadcast using this system is the Olympics, the number of viewers that wish to use the system may exceed the capacity of a single or particular CDN. This ability of the event scheduling server to replicate the encoded video content can provide a means for the mitigation of this instance and distribute the load of transmission connections to two or more CDNs.

In some embodiments, the event scheduling server includes a database or lookup mechanism which associates each piece of compressed video content with a specific supplier or owner thereof. This correlation between the compressed video content and the supplier or owner can provide the supplier or owner with the ability to manage viewer application/viewer computing device access to the video content. For example, the supplier owner can select the employees of a specific company only has access to that particular video content, wherein this video content may be related to employee training for that specific company. This correlation between the compressed video content and the supplier/owner can also provide the supplier/owner with the ability to control the timing of access to the compressed video content, for example it is accessible only for a particular time period.

According to embodiments, the event scheduling server is further comprises a module configured for the collection and/or evaluation of analytics relating to consumption of video content using the system, requests for invitations, invitations used, time of use of the system, among others. The event scheduling server if further configured for meta-data formulation and transcribing.

In some embodiments, the event scheduling server further comprises a module configured for client branding, which can for example configure interfaces and/or applications in a desired manner. For example a viewer application can be configured to have a particular branding and/or application availability, like instant messaging, metering or the like. The modification of these parameters can be enabled through a developer integration API key, which can provide the person using same with the ability to modify one or more of the APIs into a desired format.

According to embodiments, the event scheduling server is operatively connected to a billing or finance module, which is configured for the billing of clients based on the use of the system. The finance module can be provided by a 3^{rd} party finance service or can be a proprietary component of the event scheduling server. In some embodiments, the event scheduling server is configured to query the CDN for analytics relating to the use of the system, for example the number of viewing applications/viewer computing devices that used the system, time of use and specific video content accesses, for example. These analytics can subsequently be modified by the event scheduling server into a particular format suitable for the particular finance module, or may be provided to the finance module in a more raw format, namely as received from the CDN. In some embodiments, these analytics can be exported to one or more data visualization tools, which can be configured to present the data in a predetermined manner for ease of interpretation by for example the owner or operator of the secure event broadcasting system.

In some embodiments, access to event scheduling server functionalities is dependent on authorization level. A low level authorization allows access to limited functionalities of the event scheduling server and, for example, may allow for the viewing of available events, searching available events and requesting invitations to available events. A middle level authorization provides access to a wider range of event scheduling server functionalities including, for example, scheduling new events, modifying and cancelling specific scheduled events, inviting viewers to specific scheduled events, and modifying and cancelling specific scheduled events. A high level authorization provides access to the full range of event scheduling server functionalities for all events and provides for the overall management of the event scheduling server.

Interfacing between the event scheduling server and the encoder appliance and the viewer computing device/viewer application is provided by application programming interfaces (API). In some embodiments, an API provides for access, authentication, system status update, event management, invitation management, video player access and the like. In some embodiments, an API can be configured to be controlled by a developer's key, which can provide a means for the modification of actions performed by the API. For example, in some embodiments, through the use of a developer's key an API can enable white branding of the product, for example personalized video player interfaces and the like.

The event scheduling server provides access to the event by forwarding an event invitation to a viewer computing device, wherein the invitation includes a link (for example, a domain name, an http designation, a URL) to the event, an event code and access personal identification number (PIN). Additional information including start and stop times for the event, event duration may be included.

In some embodiments, the event scheduling server is configured to provide viewer level browsing, for example similar to that provided by YouTube. In these embodiments, the video content can be published and identifiable by a potential viewer. However in order for the downloading of this identified video content to be enabled, an event ID and PIN associated with an invitation can be sent from the event scheduling server to the potential viewer upon request by the potential viewer. Wherein this request by the potential viewer may be enabled upon selection thereby of the identified video content. In some embodiments, in order for the downloading of this identified video content to be enabled, this content may be published with a public key which can be configured as an unlimited, non-expiring key or the like.

In some embodiments, the event scheduling server allows an unlimited number of connections thereto based on a particular PIN. However in some embodiments, the event scheduling server is configured to specifically limit the number of connections thereto per PIN. In some embodiments, the limiting of the number of connections per PIN can be provided by a time limitation, for example an expiry date or time or both associated with the particular PIN. In some embodiments, the limiting of the number of connections per PIN may be enabled thereby limiting the number of simultaneous viewers that can view a particular video content using the same PIN. In some embodiments, this limitation can be enabled by limiting a single access per PIN, for example all viewers of a particular piece of video content have their own unique PIN.

In some embodiments, a PIN can be configured to allow a predetermined number of views of a particular piece of video content, for example a PIN provides 5 viewing of a video content and these 5 viewings can be simultaneous, serial or separated by a time period, however upon 5 viewings the PIN would no longer provide access to the particular video content with which it is associated. For example, this configuration of a viewing limitation can enable 5 different users to view the video content using the same PIN, or a single person can view the same video content 5 times using the same PIN, or combinations thereof, such that in this example the total number of viewings is equal to 5.

According to embodiments, the limitation of access provided by a specific PIN can be pre-assigned to a specific PIN or can be assigned to a specific PIN upon authorization by the event scheduling server. For example, the event scheduling server can have a collection of PINs that have pre-assigned access configurations, and may optionally or in combination with have a collection PINs wherein the access configurations are assigned at a later point. For example, later assignment of access configurations can be enabled by the specific type of access requested by a user of the system, the type of video content selected by the user or the like. As would be readily understood, the event scheduling server can store or have access to the stored information which relates a specific PIN with the specific limitation of access assigned thereto, thereby providing the event scheduling server with the parameters with which to enable or deny access to selected video content.

In some embodiments, the invitations are configured for integration into office calendaring programming, smart phone calendaring programs or the like.

The event scheduling server may optional include a module for tracking viewership statistics including amount of time viewed, etc.

### Encoder Appliance

The system includes one or more encoder appliances which comprise one or more encoders which are configured to encode and compress the video content, and subsequently upload or push this compressed video content to the CDN. Various encoding formats may be used including any one of the established encoding formats such as Moving Picture Experts Group (MPEG). For example, MPEG-1 format, MPEG-2 format, MPEG-4 format H.264/Advanced Video Coding (AVC) format, High Efficiency Video Coding (HEVC), which is also known as H.265, and the like have been established as international standard encoding formats.

In some embodiments, an encoder appliance receives video content and encodes the video content, wherein this encoding process can be performed in segments of video content, for example segments that are a predetermined length of time, or range of times (eg between 25 and 35 seconds). However, in some embodiments the encoder appliance is configured to encode the video content in a substantially constant manner, namely not in predetermined segments. As would be readily understood, the encoding of the video content can be performed in a variety of manners, segmented, continuous stream, or other manner.

The encoder appliance is configured to receive instructions from the event scheduling server, wherein these instructions relate to what to encode, how to encode, when to start encoding, when to stop encoding and where to save the encoded video content on the associated CDN. In this manner, the event scheduling server is substantially completely controlling the operation of the encoder appliance. In these embodiments, the encoder appliance is substantially in constant communication with the event scheduling server for instructions on what to do.

According to embodiments, the encoder appliance is configured to updates the event scheduling server only upon complete upload of a specific amount of the encoded video content, for example a complete segment of the video content, or the video content of an entire event, or the like. Through this update cycle performed by the encoder appliance, the system is configured to ensure video content is uploaded to the CDN prior to providing a viewer application/viewer computing device access to this video content. In some embodiments, this update provided by the encoder appliance to the event scheduling server can include data representative of the identity of the uploaded video content, location of the uploaded video content on the CDN, duration of the uploaded video segment and the like or a combination thereof.

According to embodiments, when the encoder appliance is encoding and uploading segments of the video content, tags are associated with each of segments, wherein these tags are indicative of the sequence of the segments relative to the video content of the entire event. This tagging of the segments, thereby provides for organization of the video content for provision to the viewer application/viewer computing device in an appropriate order enabling appropriate sequential presentation to the viewer.

In some embodiments, when the encoder appliance is in substantially constant communication with event scheduling server, the event scheduling server can substantially request confirmation of a desired operational status of encoder appliance.

According to embodiments, each of the one or more encoder appliances has operative thereon one or more encoding algorithms, which provide a means for the encoding/compression of the video content received by the respective encoder appliance. The encoding algorithms can include one or more picture content encoders, audio content encoders, complete video encoders or the like. During operation, the event scheduling server provides instructions to the encoder appliance which define which encoding algorithm is to be used for the encoding process.

Substantially any codec or encoder known in the art can configured for use with the system as long as it encodes and compresses video to a desired compression ratio and at desired picture quality. A worker skilled in the art would appreciate that the choice of codec or encoder can in part depend on desired compression ratio and quality. The codec or encoder may include software, firmware, hardware or a combination thereof for enabling the desired functionality. The codec or encoder may be in the form of a dedicated encoder box or hardware, a PC running the encoding and compressing software, or an encoder server programmed with encoding software capable of encoding digital data into streaming data.

In some embodiments, the encoder is provided as software. By way of non-limiting example, such encoding software is available from Microsoft Corporation, RealNetworks, Inc., Adobe and Apple, for encoding into Windows Media, RealPlayer, Flash or Quicktime format, respectively. One skilled in the art will recognize that the process of encoding audio and video data into streaming media formats may be performed in any number of ways now known or hereafter developed. In some embodiments, the encoder is configured as a proprietary codec.

According to embodiments, each of the one or more encoder appliances is configured to push the encoded or compressed video content to the CDN, wherein this pushed data has associated therewith authorization details, if required, location identification for the CDN for the storage of the received data, or other parameters that provide the CDN with necessary details required thereby.

In some embodiments, the encoder appliance is a third party component. In this configuration, the encoder appliance can have installed thereon a communication module configured to enable the desired level of communication between the encoder appliance and the event scheduling server. For example, this communication module can be configured to be responsive to the API that provides a means for the communication between the encoder appliance and the event scheduling server.

In some embodiments, the system utilizes a multi-codec or multi-encoder approach in which a video stream is analyzed and the codec or encoder best-suited for a particular frame or video sequence is automatically selected from an entire library of specialized codecs or encoders. One such system known in the art includes the propriety CodecSys software. In some embodiments, the event scheduling server is configured to perform this analysis of the video stream and subsequently instruct the encoder appliance accordingly. In some embodiments, the encoder appliance may perform this analysis, and in this situation, the encoder appliance would subsequently update the event scheduling server accordingly in order that the event scheduling server can appropriately inform the viewer application/viewer computing device. In some embodiments of the present technology, the event scheduling server is configured to analyse ancillary data, which can be indicative of instant messaging (IM)/question and answer (QA) interactive communications which are to be recorded along with the event video data, and subsequently replayed when the event video data is rebroadcast or accessed on demand at a later date.

In some embodiments, the encoder appliance comprises a dedicated hardware apparatus for compressing video comprising means for obtaining raw video content; means for separating the raw video content into picture content and audio content; means for dividing the picture content into a frame by frame configuration; means for determining frame type for compression of one or more frames of the frame by frame configuration; means for filtering one or more frames, said filtering enabling segmentation of the frame into two or more portions, each portion indicative of a desired quantization; means for encoding each portion of the frame, wherein each portion is encoded based on a respective desired quantization; means for generating encoded picture content which includes each encoded portion of the frame and its respective desired quantization; and interleaving the encoded picture content with encoded audio content resulting in compression of the raw video content.

In some embodiments, the encoder appliance comprises network enabled hardware comprising an audio/video input interface for receiving a media stream from a video source; and a media encoder operable to encode the stream from the audio/video input interface, thereby producing an encoded media stream and a network output configured to transmit the encoded media stream.

### Content Delivery Network

The content delivery network is operatively coupled to the one or more encoder appliances and the event scheduling server and is configured for receipt and storage of video content received from the one or more encoder appliances. The content delivery network is further configured to be accessible by one or more viewer computing devices/viewer applications and configured for delivery of the identified video content to the one or more viewer computing devices/viewer applications as required.

In some embodiments, the content delivery network enables uploading of video content by the encoding appliance and the delivery of the content to respective viewer applications, wherein the content delivery network is configured to require authorization from one of or both of the encoder appliance and the viewer application/viewer computing device for access to the CDN. For example, when the encoder appliance provides the compressed video content to the CDN, the encoder appliance is required to provide authorization for deposit of the data onto the CDN, wherein authorization can be in the form of a specific location for deposit, or a password or key for access or the like. In addition, a viewer application/viewer computing device is to provide the CDN with an appropriate access credentials for a particular piece of compressed video content in order to gain access thereto for downloading. For example, the appropriate access credentials can be in the form of video content identification and access code or the like.

According to embodiments, the CDN associated with the system can vary depending on the requirements of a specific event being broadcast. For example, for a large viewing audience, namely a large number of viewer application/viewer computing device requests, a particular CDN configuration may be more suitable than another, wherein suitability can be representative of the operational capacity of the specific CDN.

In some embodiments, the CDN or the required CDN functionality is provided by a 3^{rd} party, It is generic in function, typically provided by a 3^{rd} party, for example the CDN can be provided by Amazon Cloudfront CDN, Limelight Network or the like.

In some embodiments, the functionality of the event scheduling server and the CDN can be configured in to form of an integrated component.

According to embodiments, the CDN is configured to tracks viewer application/viewer computing device access and duration of this access, wherein these details can be provided to the event scheduling server for subsequent provision to the finance module for subsequent billing to the client, for example the supplier or owner of the video content or the viewer themselves or both.

According to embodiments, the CDN is configured to provide the encoder appliance with temporary deposition locations for compressed video content upload. For example, these temporary deposition locations can typically be used for real time encoding and viewing, for example during the broadcasting of substantially live events using the system.

According to some embodiments, a primary CDN is configured to perform load balancing between a plurality of CDNs, which may be suitable for a large audience, for example when a plurality of viewer applications/viewer computing devices are requesting access to the same video content or a variety but large quantity of video content, such that a plurality of downloads or deliveries of video content is occurring substantially simultaneously.

In one embodiment, the Content Delivery Network includes multiple nodes deployed in multiple locations, and optionally over multiple backbones. In some embodiments, the Content Delivery Network includes nodes having concentrations of caching servers located at key or desired Internet exchange points.

In some embodiments, the nodes cooperate with each other to satisfy requests for content by end users, transparently moving content to optimize the delivery process. Optimization can take the form of reducing bandwidth costs, improving end-user performance (reducing page load times and improving user experience), or increasing global availability of content.

In one embodiment, the Content Delivery Network is configured such that requests for content are algorithmically directed to nodes that are optimal in some way. When optimizing for performance, locations that are best for serving content to the user may be chosen. This may be measured by choosing locations that are the fewest hops, the fewest number of network seconds away from the requesting client, or the highest availability in terms of server performance (both current and historical), so as to optimize delivery across local networks. When optimizing for cost, locations that are least expensive may be chosen instead.

In one embodiment, the Content Delivery Network is a global network of edge locations or nodes, where requests are automatically routed to the nearest edge or node location.

### Viewer Application/Viewer Computing Device

The one or more viewer applications/viewer computing device are configured to communicate with the event scheduling server and receive invitations to one or more broadcasting events therefrom and subsequently download or stream the broadcasting event from the content delivery network, wherein authorization for this download or streaming is based at least in part on the invitation. The viewer computing device is configured for access to one or more communication networks which together provide a means for the viewer computing device to interact with both the event scheduling server and the CDN. For example, the one or more communication networks can be a wireless network, wired network, satellite network, cellular network, or the like or combination thereof.

The viewer computing device had installed thereon, or integrated therein in software, firmware, hardware or combination thereof, a module operative for interaction with the event scheduling server and the CDN. The viewer computing device further includes one or more codecs, and specifically at least a decoder, which is configured to decode the encoded video content upon receipt by the viewer computing device from the CDN.

According to embodiments, during the interaction between the viewer application/viewer computing device and the event scheduling server, the identification of the appropriate decoder for use by the viewer application/viewer computing device is identified, thereby enabling the use of the appropriate decoder.

In some embodiments, the viewer computing device includes an appropriate video card or other module as well as an appropriate output device, enabling the presentation of the video content to the user of the viewer computing device. Appropriate output devices in this regard would be readily understood by a worker skilled in the art and can include both image presentation and sound presentation.

According to some embodiments, the viewer computing device is further configured with the appropriate software, firmware or the like, to enable and environment of interactive chat, instant messenger, voting, quality assurance, attendee or viewer listing, moderator controls and the like or a combination thereof. In addition, in some embodiments, the API enabling the interaction between the viewer application/viewer computing device can be modified by use of an integrator API key, which can provide the owner or supplier of the content with the ability to modify the presentation or functionality of the API for this interaction. For example, this can enable the desired branding of the viewer application to be present to the viewer during the presentation of the event being broadcast.

According to embodiments, substantially any player known in the art may be used in conjunction with the system, wherein the player is configured for presentation of the decoded video content to the viewer using one or more appropriate output device. Such players can include Quicktime, Media Player, MPlayer, GOM Player, VLC, KM Player or the like or combination thereof.

### Finance Module

In some embodiments, the event scheduling server is operatively associated with a finance module in order to facilitate billing a client for use of the system. The financial module can be configured to generate invoices based on billing information from the event scheduling server and/or the CDN. In some embodiments the finance module is configured to process payment only. In some embodiments, the finance module may be specifically equipped to accommodate a variety of payment options including pre-payment, pay per use, pay per event or the like.

According to some embodiments, the finance module is provided by a third party, wherein the event scheduling server can collect data reflective of the use of the system from the CDN, and if required the event scheduling server can subsequently manipulate this collected data into a format that is suitable for the third party finance module.

In some embodiments, the finance module is a proprietary finance module configured for the system. For example, in a proprietary finance module, the data collected from the CDN by the event scheduling server can be substantially directly input into the finance module for subsequent manipulation therein and generation of the appropriate billing and/or invoicing details.

According to embodiments, billing for the provision of the video content to one or more viewer applications/viewer computing devices using this system is enabled based on a “time used basis”, which is configured akin to the billing for cell phone use. For example, when the client being billed for system use is the supplier or owner of the video content, the cost associated with the use of the system for broadcasting the particular video content will be dependent on the number of viewer applications/viewer computing devices that accessed the particular video content and the amount of time each of these viewer applications/viewer computing devices were communicating with the CDN and/or event scheduling server enabling the downloading or broadcasting. In some embodiments, the amount of time can be based on the viewing time of the particular video content.

In some embodiments, the client being billed by the system is the actual viewer, wherein the billing for this configuration can be dependent on the amount of amount of time this particular viewer's viewer application/viewer computing device was communicating with the CDN and/or event scheduling server enabling the downloading of the particular video content. In some embodiments, the amount of time can be based on the viewing time of the particular video content.

In embodiments, the finance module is configured to receive details relating to video content delivery, viewer application/viewer computing devices receiving the video content, time of use of the system by each viewer application/viewer computing device, and the like or combination thereof, which enables the billing of the appropriate client based at least in part on the time of use of the system.

According to some embodiments, additional billings can be made to the owner/supplier of the video content, wherein these additional billings can be based at least in part on the video content consumed by the one or more viewer applications/viewer computing devices, wherein parameters relating to the video content consumed can be dependent on the number of pieces of video content, the size of the video content consumed, the duration or play time of video content, the time of availability of the video content for consumption, or the like or a combination thereof.

### Pricing Methods

The pricing method that can be applied to the system can take on a plurality of formats, and can be dependent on who the client is and the type of video content being broadcast among other parameters for example. The following embodiments of pricing configurations are merely examples and are not to be considered exhaustive examples of pricing methods in any way. A worker skilled in the art would readily appreciate that various other configurations of pricing methods can be applied to this system.

According to some embodiments, wherein the client being billed is the supplier/owner of the video content, the viewer may be provided with access to video content free of charge, for example if the video content is related to a company training session, available on a flat fee basis, for example if the video content relates to movies, or a per access charge, for example in line with a on-demand pricing model. Pricing of video content can be determined in part by the nature of the video content, length of video content, time of use or downloading of the video content, re-play options of the video content, availability for downloading of the video content and the like or combinations thereof. In some embodiments, pricing methods may consider the relevance of advertisements.

In some embodiments, the client is billed based in part on the length or duration of the video content. Accordingly, profit margins may at least in part be dictated by the compression ratio of the video content, as at the present time the associated costs to download the video content is dependent on bandwidth used. For example, the system operator may be billing the client on a time of use basis of the system or duration of the video. And the owner of the system according to the present invention will likely be billed by the CDN on the number of bytes transferred or downloaded. In this configuration, if the compressed video content is encoded to a fewer number of bytes while still retaining the desired quality of the decoded video stream, the owner of the system can increase profitability by enhancing the compression of the video content. In some embodiments, where profits margins are to be substantially maximized the video content input is compressed to the highest possible amount while maintaining a desired level of video quality.

In some embodiments, the costs associated with the operation of the system are dependent on the amount of video content that is delivered through the content delivery network. In such embodiments, profits margins for the owners of the system can be increased by increasing compression of the original video content.

A method of operation of the system is defined below. In some embodiments, an event is scheduled and instructions are sent from the event scheduling server to the one or more encoder appliances detailing parameters including for example, event start and stop times, appropriate encoder configuration, compression ratio and quality. The video content is inputted into the encoder appliance and compressed. The compressed video content is subsequently uploaded to a content delivery network. Distribution parameters and video content locations are set or the content is otherwise tagged to facilitate retrieval. Uploaded content may be configured for download or for streaming Upon completion of the uploading of the video content onto the content delivery network, the encoder appliance can send a communication to the event scheduling server of the completion of same.

Prior to the event start time, the event scheduling server sends an invitation to one or more viewers via a respective viewer application/viewer computing device. The invitation provides the viewers with the details for interaction with the event scheduling server for obtaining details regarding access to the event video content from the content delivery network. For example, the invitation can provide a link to the event scheduling server, wherein upon the authorization of the particular viewer, by way of for example password or the like, the event scheduling server can provide the viewer/viewer application with details for downloading the desired video content from the content delivery network. For example these details can include a domain name of the content delivery network, location of the desired video content on the content delivery network, access code and personal identification number (PIN) for provision to the content delivery network, and the like or combination thereof. Upon authorization of the viewer application/viewer computing device's access to the desired video content, the content delivery network can commence the transmission of that desired video content to the viewer application/viewer computing system. Finally, the viewer application/viewer computing device receives from the event scheduling server previously or on an ongoing basis, parameters for the decoding of the video content, wherein these parameters can be encoder configuration, order of multi-portion video content and the like. The viewer application/viewer computing subsequently sequentially decodes the downloaded video content and presents same to the viewer via an output device, which can include both image and sound generation.

It will be appreciated that, although specific embodiments have been described herein for purposes of illustration, various modifications may be made without departing from the spirit and scope of the invention. In particular, it is within the scope of the invention to provide a computer program product or program element, or a program storage or memory device such as a transmission medium, magnetic or optical wire, tape or disc, or the like, for storing signals readable by a machine, for controlling the operation of a computer according to the method of the invention and/or to structure its components in accordance with the system of the invention.

Further, each step of the methods may be executed on a general computer, such as a personal computer, server or the like and pursuant to one or more, or a part of one or more, program elements, modules or objects generated from any programming language, such as C, C++, Java, Perl, PL/1, or the like. In addition, each step, or a file or object or the like implementing each said step, may be executed by special purpose hardware or a circuit module designed for that purpose.

The invention will now be described with reference to specific examples. It will be understood that the following example is intended to describe embodiments of the invention and are not intended to limit the invention in any way.

### Example

The following example provides user case scenarios for use of and interaction with the components of the system. A user case is presented from the position of the encoder appliance, the viewer of the video content, and the client of the system, namely the owner or supplier of the video content.

### Encoder Appliance Use Case

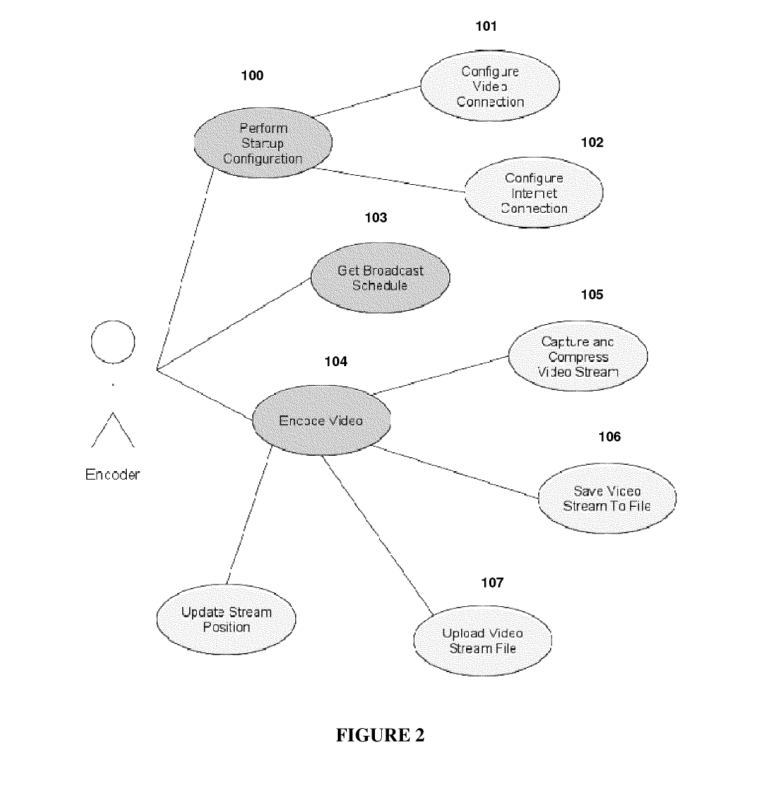

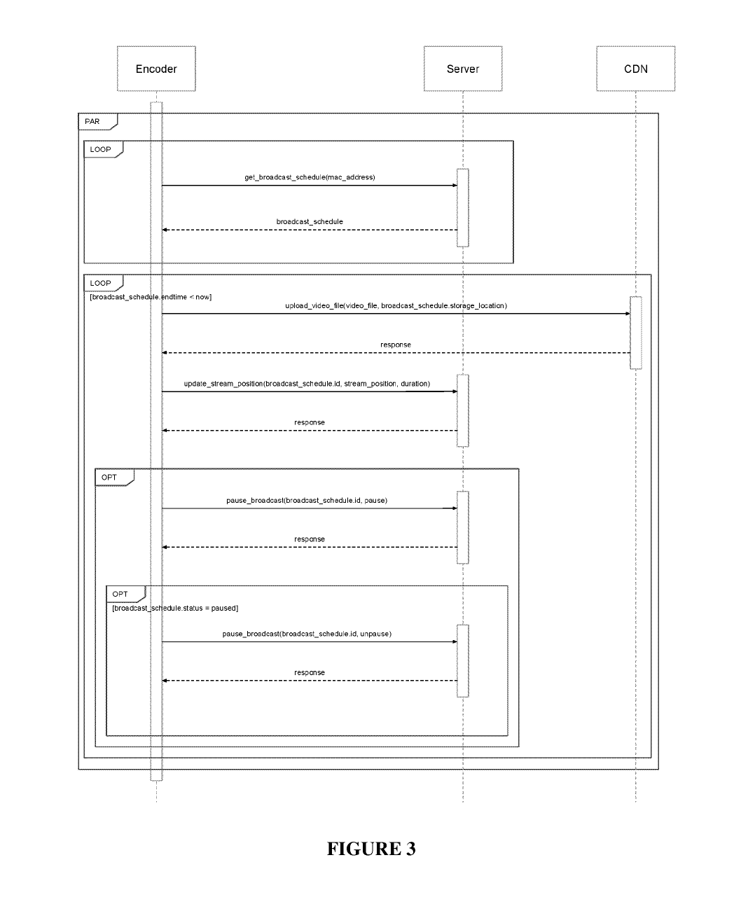

With reference to FIGS. 2 and 3 an encoder appliance use case and sequence diagram are discussed below, in accordance with embodiments of the present technology.

### Perform Start-Up Configuration 100:—Configure Video Connection 101

On power on the encoder appliance auto-senses the type of video feed connected to it's video input port and sets any necessary video specific settings. If no video feed is connected to the video input ports at power on, the encoder appliance auto-senses the type of video feed as soon as it is connected.

### Perform Start-Up Configuration:—Configure Internet Connection 102

On power on the encoder appliance will automatically detect and configure network settings to enable it to connect to the Internet. This is done via standard DHCP and includes setting IP address, Subnet, Gateway and DNS settings. These settings can be manually overridden using the LCD configuration panel on the front of the encoder.

### Get Broadcast Schedule: 103

Once powered on, the encoder appliance checks with the event scheduling server every 2 seconds for details of any upcoming broadcasts or adjustments to the currently running broadcast. The encoder appliance's unique network card address (it's MAC address) is used to identify the encoder appliance on the system. A broadcast is only notified to an encoder appliance as an upcoming broadcast schedule when it starts in 15 minutes from the time of the check. When the encoder appliance receives an upcoming broadcast schedule, the schedule includes a unique broadcast ID, the broadcast title, details of the time to start and end encoding, video settings, audio settings and where to upload the encoded video.

According to embodiments, an encoder appliance should be left permanently on and connected to the Internet. If this is not desired or possible an encoder appliance is to be powered on 15 minutes before it is scheduled to start broadcasting. It is the responsibility of the encoder owner to ensure this occurs.

### Encode Video 104:—Capture and Compress Video Stream 105

At the specified broadcast start time the encoder appliance will begin capturing and compressing video from the connected video input port according to the video and audio settings defined in the broadcast schedule the encoder appliance received.

### Encode Video:—Save Video Stream to File 106

The broadcast schedule includes a ‘duration’ setting. This is a guide as to how long video should be captured and compressed for before it is saved to file. Once this duration has been reached the encoder appliance will save the captured and compressed video to file at the next key frame. The file is saved with a sequentially numbered filename. This sequential number is the position in the broadcast of that particular file. Whilst the encoder appliance is saving this video to file it is still capturing and compressing video ready to be saved as the next sequentially numbered filename.

### Encode Video:—Upload Video Stream File 107

When the encoder appliance has saved a video stream file to disk it is uploaded to the content delivery network and optionally the event scheduling server and stored in a unique secure location specific to the broadcast. The video file remains permanently stored and archived on the event scheduling servers, unless it is deleted manually.

### Encode Video:—Update Stream Position 108

When a video stream file has been uploaded to the content delivery network and optionally the event scheduling server, the encoder appliance also notifies the event scheduling server of the stream position (the last uploaded file), as determined by the files sequentially numbered filename along with the duration of the file as measured in milliseconds. This stream position is used, by any viewer applications/viewer computing devices watching the broadcast, to determine when the next video file is available for download; while the duration is used for viewing analytics.

### Viewer (Viewer Application/Viewer Computing Device) Use Case

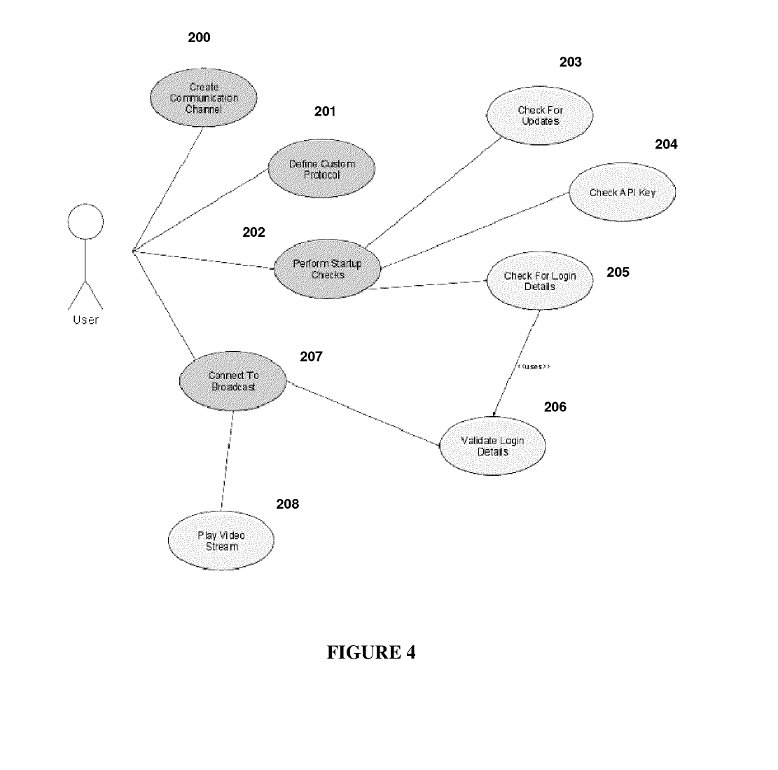

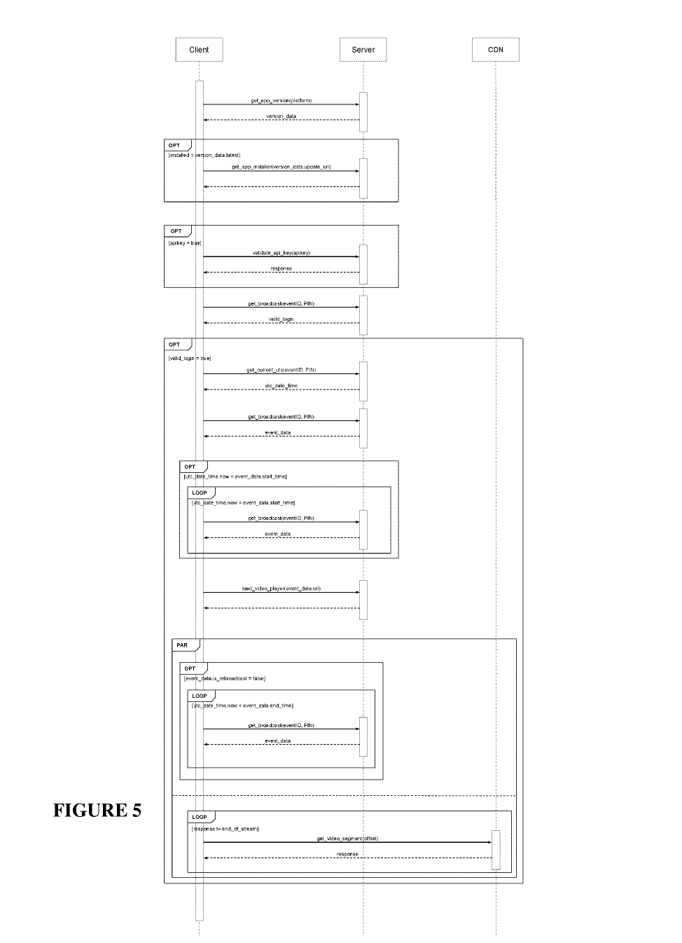

With reference to FIGS. 4 and 5 a viewer/viewer application/viewer computing device use case and sequence diagram are discussed below, in accordance with embodiments of the present technology.

### Create Communication Channel: 200

The viewer application creates a secure communication channel which can be used by external applications to make calls to the event scheduling server using the defined API. This API allows the viewer application to be launched and controlled by another application, in a master/slave environment. The provided control capabilities include logging in, video playback control and application size and positioning.

### Define Custom Protocol: 201

The viewer application defines a custom uniform resource identifier (URI) protocol. This protocol is registered with the event scheduling server and viewer application during the installation of the viewer application. Once registered, the URI protocol is then associated with that viewer application. Then, when a link of the form URI is encountered, (by the users web browser), the viewer application is launched and the parameters contained within the link are passed to the viewer application as command line parameters.

### Perform Start-Up Checks 202:—Check for Updates 203

The viewer application checks for any application updates as part of its start-up process. If an update is found the user will be notified. An update will either be required or optional. If the update is required, the user must accept the update to continue using the viewer application. Once accepted the update will automatically be downloaded and installed.

### Perform Start-Up Checks:—Check API Key 204

The viewer application checks for the existence of an API Key, passed as a command line parameter, when the viewer application is started. If an API key is present it is validated with the event scheduling server. A valid API key is required for the viewer application to respond to control calls from an external application. It also enables the viewer application to run with no user interface, so that once the login credentials are validated, only the video stream is displayed at a position and size determined by the external application. In a user interface-less scenario, video playback controls are only possible from the external application, namely the player associated with the viewer computing device.

### Perform Start-Up Checks:—Check for Login Details 205

The viewer application checks for the existence of login details, passed as command line parameters, when the viewer application is started. If login details exist, the viewer application automatically uses these when attempting to connect to a broadcast.

This check, along with the definition of a custom URI protocol, allows the event scheduling server to send out email invites to attendees, to watch a broadcast. The invite contains the attendees access details and a link that can be used to launch the viewer application with the relevant access details. This allows for automatic connection to the required broadcast without the need to manually enter login details.

### Connect to Broadcast:—Validate Login Details 206

Once start-up has completed the viewer application requires that the user enter login details in order to securely access and connect to a broadcast. If the login details are valid the viewer application retrieves details of the relevant broadcast.

If the broadcast has not yet begun the user is shown a countdown to the broadcast start time. As soon as the broadcast starts the viewer application will connect the user to the broadcast.

If there is a delay in the broadcast start time, the user is notified and the viewer application connects the user to the broadcast as soon as it is available.

If the broadcast has already started, the user can choose to connect to the broadcast from its current position or from the start of the broadcast.

### Connect to Broadcast 207:—Play Video Stream 208

Once the user is connected to the broadcast, they are shown the broadcasts live video feed. Video playback controls are available to pause/resume playback, adjust the volume level, as well as view the broadcast in full screen mode.

### Client (Owner/Supplier of Content) Use Case

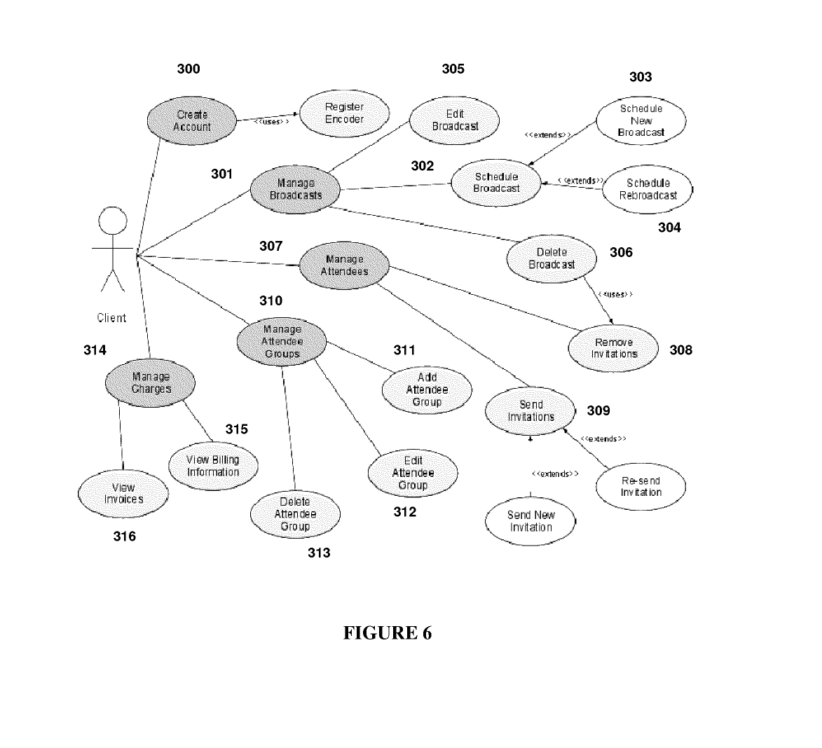

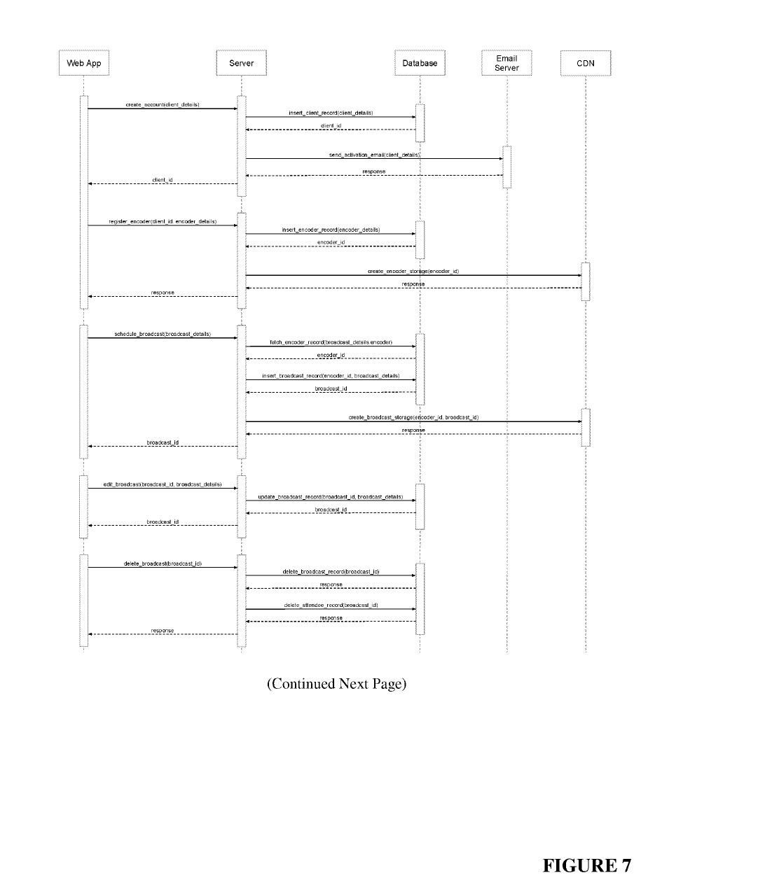

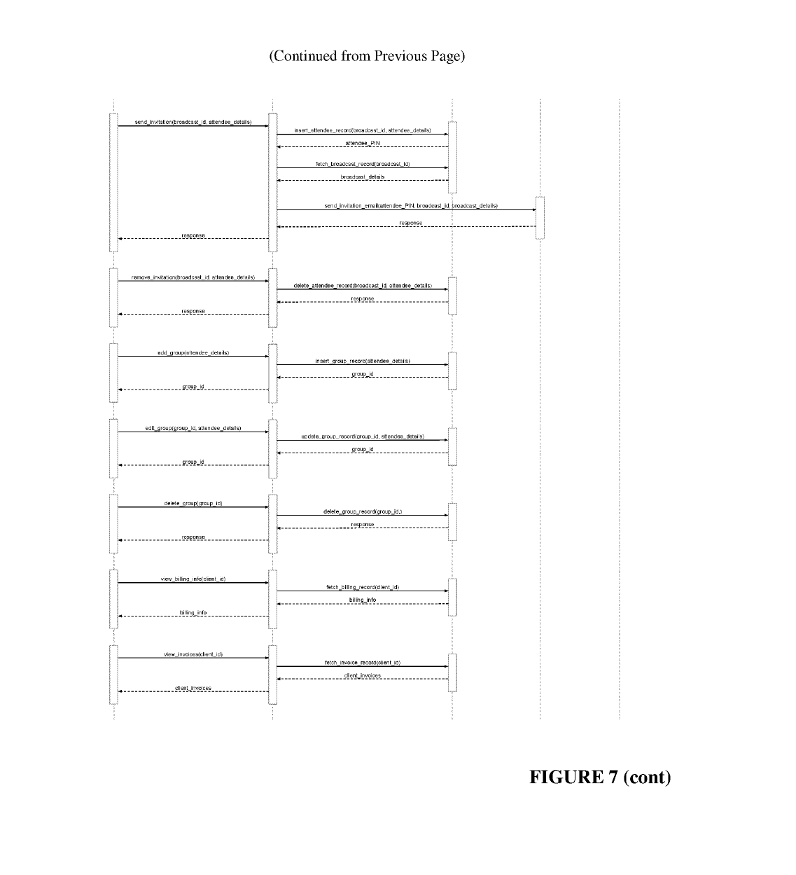

With reference to FIGS. 6 and 7 a client (owner/supplier of video content) use case and sequence diagram are discussed below, in accordance with embodiments of the present technology.

### Create Account: 300

A new client is required to enter a username, first and last name, email address and password. This creates an account for the user/client on the system and assigns a unique ID to the client used to identify them in all other interactions with the event scheduling server. Once the email address has been validated the user is required to enter the serial number of their purchased encoder appliance. This is used to uniquely identify the user's encoder appliance on the event scheduling server and associates it with the users unique ID. The event scheduling server then creates a unique storage area where all broadcast video data for that encoder appliance will be stored.

### Manage Broadcasts 301:—Schedule Broadcast 302

A client can schedule a new broadcast 303 or a re-broadcast 304. A re-broadcast is the broadcast of existing broadcast video data.

Scheduling a new broadcast requires the client to select the encoder appliance to be used for the broadcast, enter a title, select a time zone (for the broadcast start time and end time), enter a start and end time and choose a disallow time (the length of time after the broadcast has ended for which it should still be available for viewing). A disallow time of ‘Never’ may be selected which means that once finished the broadcast will be available for viewing forever. The event scheduling server then creates a unique ID for the broadcast and creates a specific storage area, within the selected encoder appliance's storage area, for this particular broadcast's video data.

Scheduling a re-broadcast requires the client to select the original broadcast for which they have permission to re-broadcast, enter a title, select a time zone (for the broadcast start time), enter a start time and choose a disallow time (the length of time after the broadcast has ended for which it should still be available for viewing). A disallow time of ‘Never’ may be selected which means that once finished the broadcast will be available for viewing forever. The event scheduling server then creates a unique ID for the re-broadcast and links this to the specific storage area of the original broadcast, where that particular broadcast's video data is stored.

### Manage Broadcasts:—Edit Broadcast 305

Once a broadcast or re-broadcast has been scheduled a client can change the broadcast encoder (new broadcasts only), title, time zone, start time, end time (new broadcasts only) and disallow time. When a broadcast or re-broadcast has been changed invitations to the broadcast will need to be re-sent, and may be re-sent automatically, with the new details.

### Manage Broadcasts:—Delete Broadcast 306

A client can delete a scheduled broadcast or re-broadcast. Deleting a broadcast will also delete any invitations associated with that broadcast.

### Manage Attendees 307:—Send Invitations 309

Once a broadcast has been scheduled a client can invite people to view the broadcast. Inviting attendees requires the client to enter a list of email addresses. Alternatively a list of email addresses may be imported in a common csv format. A custom message may also optionally be entered. The event scheduling server then creates a unique access PIN code for each invited attendee and associates this with the selected broadcast ID.

Each attendee is then sent an email with details of the broadcast and a unique link that they can use to launch the viewer application from the email and automatically connect to the broadcast using the correct PIN code and broadcast ID. If the attendee does not have the viewer application installed on their computing device they will be prompted to download and install the viewer application.

A client can choose to re-send all invitations, as a reminder of the upcoming broadcast, any time up to the start time of the broadcast.

A PIN code and broadcast ID emailed to an attendee remains valid to connect to the broadcast up to the disallow time set for that broadcast.

### Manage Attendees:—Remove Invitations 308

A client can remove all or specific attendee invitations that have already been sent. This will remove the specific PIN code from the system and break the association with the broadcast ID so that an invited attendee will no longer be able to use the sent PIN code and event ID to connect to the broadcast. It will also email the attendee to notify them that they will no longer be able to access the broadcast.

### Manage Attendee Groups 310:—Add Attendee Group 311

A client can define groups of email addresses as an attendee group. An attendee group, or multiple attendee groups, can be invited to an event as a whole to streamline the invitation process. Once a group has been added to the invited list, specific attendees may be removed before the invitations are sent.

If an email address belongs to more than one group and both the groups are invited to the same event, the invite is only sent out once.

### Manage Attendee Groups:—Edit Attendee Group 312

A defined attendee group can be edited to add or remove email addresses from the group. The group can be ‘temporarily edited’ whilst adding a group to an invite list for a broadcast, so that only certain members of the group are added. Temporarily editing the group in this manner would not permanently remove email addresses from the group.

### Manage Attendee Groups:—Delete Attendee Group 313

A defined attendee group may be deleted. Once deleted the group cannot be restored. If the same email address appears in more than one attendee group, only the deleted group will be affected. All other occurrences of the email address in other groups remain intact.

### Manage Charges 314:—View Billing Information 315

A client can register a credit card with the event scheduling server which will then be used for all monthly and one-off charges.

### Manage Charges:—View Invoices 316

A client can view all paid and outstanding invoices. They may also pay any outstanding invoices.

It is obvious that the foregoing embodiments of the invention are examples and can be varied in many ways. Such present or future variations are not to be regarded as a departure from the spirit and scope of the invention, and all such modifications as would be obvious to one skilled in the art are intended to be included within the scope of the following claims.

We claim:

1. A secure event broadcasting system comprising:
an event scheduling server configured to provide event management and invitation access management;
one or more encoder appliances configured to encode and upload content to a content delivery network in response to instructions from the event scheduling server; and
one or more viewer applications configured to communicate with the event scheduling server and receive invitations to one or more broadcasting events therefrom;
wherein specific uploaded content corresponds to a broadcasting event and the invitation at least in part provides access to the specific uploaded content on the content delivery network.

2. The secure event broadcasting system according to claim 1, wherein interaction between the event scheduling and the one or more encoder appliance includes a substantially continual handshake.

3. The secure event broadcasting system according to claim 1, wherein interaction between the event scheduling and the one or more viewer applications includes a substantially continual handshake.

4. The secure event broadcasting system according to claim 1, wherein the event scheduling server is operatively coupled to a storage device configured to store one or more broadcasting event.

5. The secure event broadcasting system according to claim 4, wherein the broadcasting event is stored in a compressed format.

6. The secure event broadcasting system according to claim 1, wherein the event scheduling server is configured to replicate specific uploaded content for subsequent provision to one or more additional content delivery network.

7. The secure event broadcasting system according to claim 1, wherein the event scheduling server includes a database or lookup mechanism which associate each specific uploaded content with a specific supplier or owner thereof.

8. The secure event broadcasting system according to claim 1, further comprising a module configured for collection or evaluating or both of analytics relating to consumption of the specific uploaded content.

9. The secure event broadcasting system according to claim 1, wherein the event scheduling server is operatively coupled to a finance module configured to bill a clients based on access to the specific uploaded content, the specific uploaded content associated with the client.

10. The secure event broadcasting system according to claim 9, wherein a specific client is billed at least in part based on a length or duration of time required for viewing the specific uploaded content.

11. The secure event broadcasting system according to claim 1, wherein each invitation includes a link to the specific uploaded content and a personal identification number (PIN).

12. The secure event broadcasting system according to claim 11, wherein a specific PIN has associated therewith one or more access parameters, wherein the one or more access parameters are configured to limit access to the specific uploaded content.

13. A method for secure event broadcasting comprising:
receiving video content of an event;
compressing the video content at a specified compression ratio and video quality to obtain a compressed video having a specific quality in response to instructions from a event scheduling server;
uploading compressed video content to a content delivery network;
providing an invitation to the event to a viewer application, wherein the viewer application can access and playback the compressed video content from the content delivery network based at least in part on the invitation.

14. The method for secure event broadcasting according to claim 13, wherein interaction between the event scheduling server and the viewer application includes a substantially continual handshake.

15. The method for secure event broadcasting according to claim 13, wherein the event scheduling server stores the compressed video content.

16. The method for secure event broadcasting according to claim 13, wherein the event scheduling server replicates the compressed video content for subsequent provision to one or more additional content delivery network.

17. The method for secure event broadcasting according to claim 13, wherein the event scheduling server associates each specific compressed video content with a specific supplier or owner thereof.

18. The method for secure event broadcasting according to claim 13, further comprising collecting or evaluating or both analytics relating to consumption of the compressed video content.

19. The method for secure event broadcasting according to claim 13, preparing and sending an invoice to a client based on access to the compressed video content, said compressed video content associate with the client.

20. The method for secure event broadcasting according to claim 19, wherein a specific client is billed at least in part based on a length or duration of time required for viewing the compressed video content.

21. The method for secure event broadcasting according to claim 13, wherein each invitation includes a link to the compressed video content and a personal identification number (PIN).

22. The method for secure event broadcasting according to claim 21, wherein a specific PIN has associated therewith one or more access parameters, said one or more access parameters configured to limit access to the compressed video content.
